(19) United States
(12) Patent Application Publication
(10) Pub. No.: US 2016/0216384 A1
(43) Pub. Date: Jul. 28, 2016

(54) DETECTION OF NUCLEAR RADIATION VIA MERCUROUS HALIDES

(71) Applicant: Brimrose Technology Corporation, Sparks, MD (US)

(72) Inventors: Henry CHEN, Ellicott City, MD (US); Joo-Soo KIM, Perry Hall, MD (US); Feng JIN, Nottingham, MD (US); Sudhir TRIVEDI, Nottingham, MD (US)

(21) Appl. No.: 14/988,324

(22) Filed: Jan. 5, 2016

Related U.S. Application Data
(60) Provisional application No. 62/107,586, filed on Jan. 26, 2015.

(51) Int. Cl. G01T 1/24

(52) U.S. Cl. CPC G01T 1/241

(57) ABSTRACT

A nuclear radiation detector includes a solid-state detector material of formula Hg₂X₂, where X is a halogen. The material is formulated to produce an analytically measurable electrical response to nuclear radiation at room-temperature. One or more electrodes are disposed on the detector material at which an electrical response is obtained.

### RELATED APPLICATION DATA

This application claims priority under 35 U.S.C. §119(e) from U.S. Provisional Patent Application No. 62/107,586 entitled “DETECTION OF GAMMA AND PARTICLE RADIATION VIA MERCUROUS HALIDES,” filed Jan. 26, 2015. The disclosure of this provisional patent application is incorporated herein by reference in its entirety.

### GOVERNMENT LICENSE RIGHTS

The invention disclosed herein was made with government support under contract numbers W911 SR-14-C-0065, W911QX-06-C-0074 and W911QX-06-C-0074-P0006 awarded by the United States Army; number NNX15CP7OP by NASA/JPL and number FA8051-15-P-0011 by DOD/US Air Force. The government has certain rights in the invention.

### TECHNICAL FIELD

The present disclosure relates to room-temperature semiconductor radiation detectors and materials used for detection of ionizing radiation, e.g., x-rays, gamma rays, neutron, alpha particles, beta particles, free neutrons and others.

### BACKGROUND

Radiation detectors are ubiquitous; they are used in such fields of endeavor as medical imaging, scientific research, security, combat theater awareness, etc. However, existing radiation detection systems rely heavily on technologies that were developed decades ago. Such relatively old technologies include scintillator based detectors such as thallium-doped sodium iodide (NaI(Tl)) or thallium-doped cesium iodide (CsI(Tl)) detectors; those that exhibit low performance; e.g., silicon (Si) semiconductor detectors; and/or those that require cryogenic cooling, e.g., high-purity germanium (HPGe) detectors.

Over the past 20 years, the demand for room-temperature semiconductor detectors (RTSDs) has steadily grown, particular in the fields of security and defense, space research and medicine. The general requirement for room-temperature operation of a semiconducting material as a nuclear radiation detector and spectrometer is relatively large band gap energy so that thermal generation of charge carriers is kept to a minimum. At the same time, high detector resolution requires small band gap energy so that a large number of electron-hole pairs are created for an absorbed quantum of ionizing radiation. Materials under consideration should also have a relatively high average atomic number, if used in gamma ray spectroscopy, to increase the gamma ray interaction probability. High charge carrier mobility and long charge carrier lifetime are also needed to ensure efficient charge carrier extraction and minimal effects from position dependent charge collection.

Research in recent years has led to some new RTSD materials, such as cadmium zinc telluride (CdZnTe or CZT) and thallium bromide (TlBr). However, widespread use of these new materials is impeded by high cost, low production yields, crystal growth constraints, e.g., single crystals of high volume, and, in the case of certain materials such as TlBr, reliability and health hazard issues.

Accordingly, engineering, research and development efforts are ongoing to produce RTSDs that not only overcome the limitations discussed above, but also have wideband detection characteristics, e.g., can be used for both gamma ray and neutron detection.

### SUMMARY

A nuclear radiation detector includes a solid-state detector material of formula Hg₂X₂, where X is a halogen. The material is formulated to produce an analytically measurable electrical response to nuclear radiation at room temperature. One or more electrodes are disposed on the detector material at which an electrical response is obtained.

### BRIEF DESCRIPTION OF THE DRAWINGS

FIGS. 1A-1B are diagrams representing room-temperature semiconductor detector (RTSD) material embodiments of the present general inventive concept.

FIG. 2 is a flow diagram of a material fabrication process that can produce RTSD material embodying the present general inventive concept.

FIGS. 3A-3C are spectral response graphs of example embodiments of the present general inventive concept at various levels of material purity.

FIGS. 4A-4C is a process diagram illustrating an exemplary device fabrication process that can be used in conjunction with embodiments of the present general inventive concept.

FIGS. 5A-5B are graphs illustrating electrical resistance properties of an exemplary embodiment of the present general inventive concept.

FIGS. 6A-6D are spectral response graphs of example embodiments of the present general inventive concept.

FIGS. 7A-7B is a table summarizing various aspects of embodiments of the present general inventive concept as compared to representative existing room-temperature semiconductor radiation detection technologies.

FIG. 8 is a table summarizing various aspects of embodiments of the present inventive concept as compared to non-room-temperature semiconductor technologies and representative scintillator-based and gas-based detector technologies.

### DESCRIPTION

The present inventive concept is best described through certain embodiments thereof, which are described in detail herein with reference to the accompanying drawings, wherein like reference numerals refer to like features throughout. It is to be understood that the term invention, when used herein, is intended to connote the inventive concept underlying the embodiments described below and not merely the embodiments themselves. It is to be understood further that the general inventive concept is not limited to the illustrative embodiments described below and the following descriptions should be read in such light.

Additionally, the word exemplary is used herein to mean, “serving as an example, instance or illustration.” Any embodiment of construction, process, design, technique, etc., designated herein as exemplary is not necessarily to be construed as preferred or advantageous over other such embodiments.

The present disclosure is directed to room-temperature semiconductor detector (RTSD) materials and detectors fabricated from such material. Materials embodying the present invention is a mercurous halide Hg₂X₂ crystal material, where X is a halogen such as iodine (I), chlorine (Cl) or bromine (B), expressed herein as “X∈{I, Cl, Br}.” RTSD material embodiments of the present invention address most of the issues faced by current room-temperature nuclear radiation detection technologies.

Nuclear radiation is made up of energetic subatomic particles, ions or atoms moving at high speeds (greater than 1% of the speed of light), and electromagnetic waves on the high-energy end of the electromagnetic spectrum. The nuclear radiation targeted by embodiments of the present invention include x-rays, gamma rays, alpha particles, beta particles and neutrons; however, it is to be understood that the present invention is not limited to these particular manifestations of nuclear radiation. As will be described below, the RTSD materials embodying the present invention are wideband materials capable of detecting, for example, gamma rays and alpha particles concurrently.

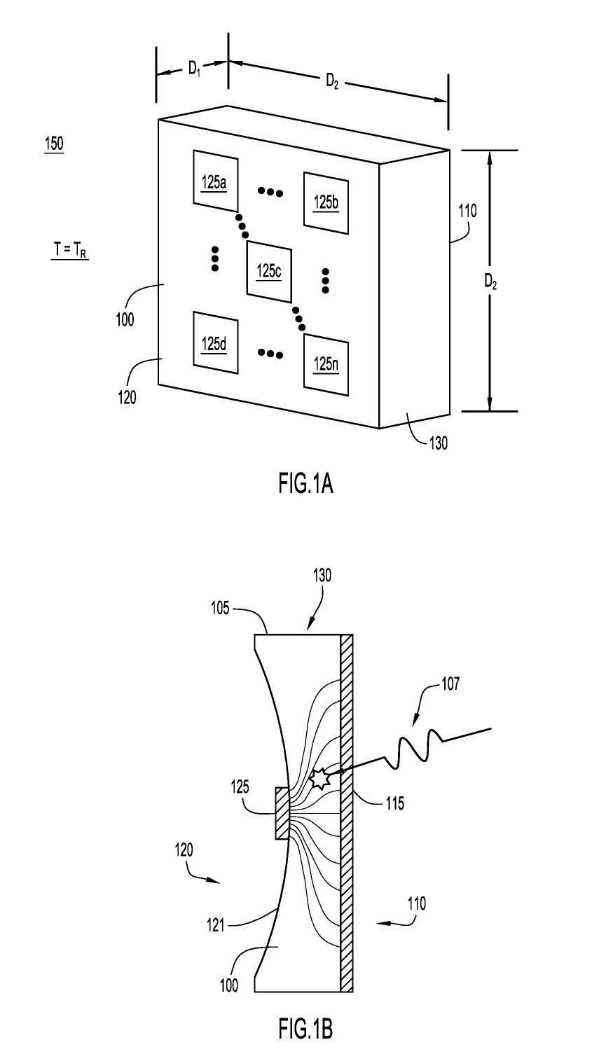

FIGS. 1A-1B, collectively referred to herein as FIG. 1, depicts a volume D₁×D₂×D₃ of RTSD material, referred to herein as detector material 100, embodying the present invention. For purposes of description and not limitation, detector material 100 is bound by an obverse surface 110, an opposing reverse surface 120 and a peripheral surface 130. It is to be understood that the terms “obverse,” “reverse,” and “peripheral” are chosen solely to distinguish one surface from another and not for defining a particular spatial orientation of detector material 100. Obverse surface 110 and reverse surface 120 need not be parallel planes, as they are depicted in FIG. 1A. Indeed, certain embodiments of the present invention, such as that illustrated in FIG. 1B, include a pseudo-hemispherical surface 121 formed over obverse surface 110. It is to be understood that detector material 100 may be formed into a variety of shapes and detecting surface configurations, as those having skill in the semiconductor arts will recognize and appreciate.

Detector material 100 may be sectioned from a boule of mercurous halide Hg₂X₂, X∈{I, Cl, Br} and electrodes may be disposed on surfaces of detector material 100. For example, a cathode 115 may be disposed on obverse surface 110 and one or more anodes 125a-125n, representatively referred to herein as anode(s) 125, may be disposed on reverse surface 120.

An electric field 105 may be established between cathode 115 and anode(s) 125 and an analytically measureable electrical response may be obtained from the material via the electrodes. As used herein, an “analytically measurable response” is a reaction of the material to a suitable stimulus, e.g., nuclear radiation 107, that can be resolved for purposes of analysis. An “analytically measurable electrical response,” refers to the case where the reaction is manifested in electrical energy output, as opposed to, for example, optical energy output, which is the case for scintillation detector materials. The analytically measurable electrical response of embodiments of the present invention is of sufficient resolution to distinguish separate ionizing events without conversion equipment, e.g., scintillation counters. Electrical energy arising from such ionizing events may be collected at the electrodes in a conventional manner. In certain embodiments, the electrodes, e.g., anodes 125 are disposed at intervals across the reverse surface 120, where each anode 125 collects the electrical energy of ionization occurring in its neighborhood, e.g., a pixel.

As illustrated in FIG. 1, detector material 100 may be positioned in a region 150 having a temperature T =T_{R}, i.e., room temperature. As used herein, “room temperature” refers to a temperature of 293.15 K (20° C.)<T<298.15 K (25° C.); although it is to be understood that detectors embodying the present invention can be used outside this temperature range. However, it is to be understood that the aforementioned analytically measurable electrical response of embodiments of the present invention occurs within this temperature range and, accordingly, cooling equipment is unnecessary. Thus, detectors using the RTSD material 100 of the present invention require substantially less space than other radiation detectors that rely on cooling equipment for operation.

Detector materials may be characterized by the electron mobility-lifetime product (μτ)ₑ, or, as used herein, simply μτ. As the name suggests, the symbol μτ represents the product of an electron's mobility μ=E/ν_{d} (where E is electrical field strength V/D₁, V is the bias voltage, D₁ is the material thickness, and ν_{d} is the average drift velocity of an electron under the electrical field) and its lifetime τ, the average drift time before the electron is recombined with a hole in the valence band. As described below, increasing purity levels of the RTSD material embodying the present invention manifests itself as an increase in μτ.

Another characterizing parameter of radiation detectors is the detector resolution, i.e., the amount of separation between peaks of neighboring spectra. The width of spectrographic peaks is determined by the resolution of the detector; high resolution allows one to distinguish separate spectral lines that are close to each other. The peak shape is usually considered as following a Gaussian distribution where the central position of the peak is determined by the energy of the incoming nuclear radiation, and the area under the peak is determined by the intensity of the nuclear radiation and by the efficiency of the detector.

A common figure used to express detector resolution is full width at half maximum (FWHM), i.e., the width of the spectral peak at half of the highest point on the peak distribution. Resolution figures are given with reference to specified nuclear radiation energies. Resolution can be expressed in absolute (i.e., eV or MeV) or relative terms. For example, a sodium iodide (NaI) detector may have a FWHM of 9.15 keV at 122 keV, and 82.75 keV at 662 keV. These resolution values are expressed in absolute terms. To express the resolution in relative terms, the FWHM in eV or MeV is divided by the energy of the incident nuclear radiation and multiplied by 100. Using the preceding example, the resolution of the NaI detector is 7.5% at 122 keV, and 12.5% at 662 keV. A germanium detector may have a resolution of 560 eV at 122 keV, yielding a relative resolution of 0.46%.

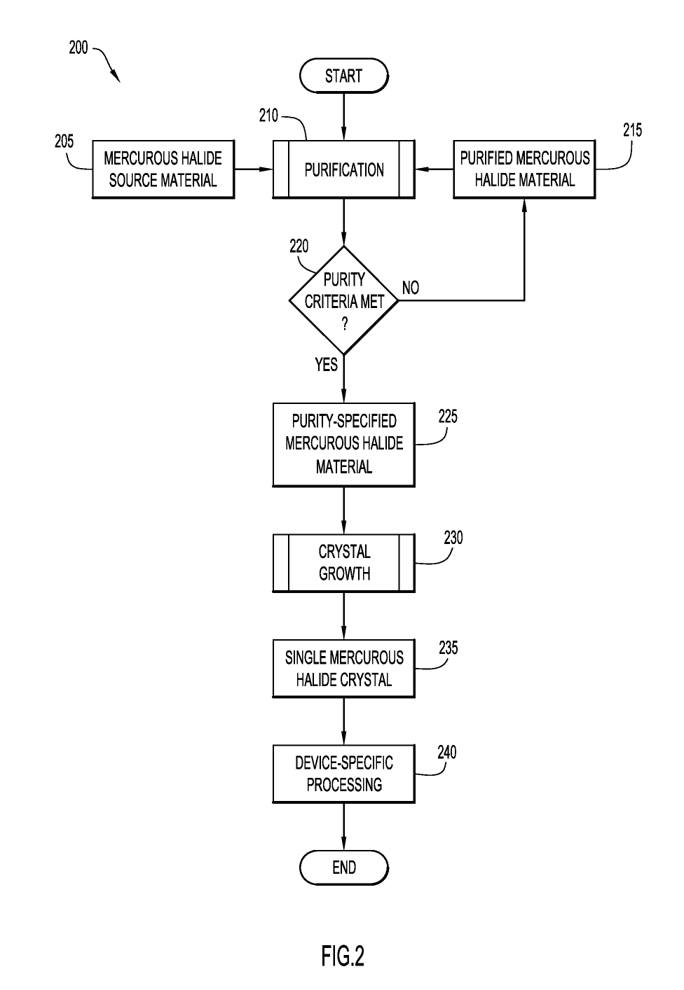

FIG. 2 is a flow diagram of an RTSD material process 200 by which embodiments of the present invention can be fabricated. Mercurous halide source material 205 may be introduced to a purification process 210. Source material 205 may be obtained in a commercially acceptable purity level, e.g., 3N (i.e., 99.9%) and purified by purification process 210 to a predetermined target purity level, e.g., 6N+(i.e., >99.9999%). Purification process 210 may be a sublimation process; mercurous halide powder may be heated under vacuum conditions to volatize the solid material. The gas phase material may then be exposed to a cooled surface, such as a cold finger, on which the purified compound may be collected. It is to be understood, however, that the present invention is not limited to particular purification techniques.

In operation 220, it is determined whether a purity criterion has been met, e.g., whether the purified mercurous halide material is at least 6N pure. If the criterion has not been met, purified mercurous halide material 215 is re-introduced to purification process 210. Re-purification is repeated until the purity criterion is met, as determined in operation 220, at which point purity-specified mercurous halide material 225 is provided.

Purity-specified material 225 may be provided to crystal growth process 230 by which a single mercurous halide crystal 235. Crystal growth process 200 may include physical vapor transport (PVT) techniques, although the present invention is not so limited. Mercurous halide crystal 235 may undergo device-specific processing 240, such as slicing, polishing, passivation and application of conductive contacts.

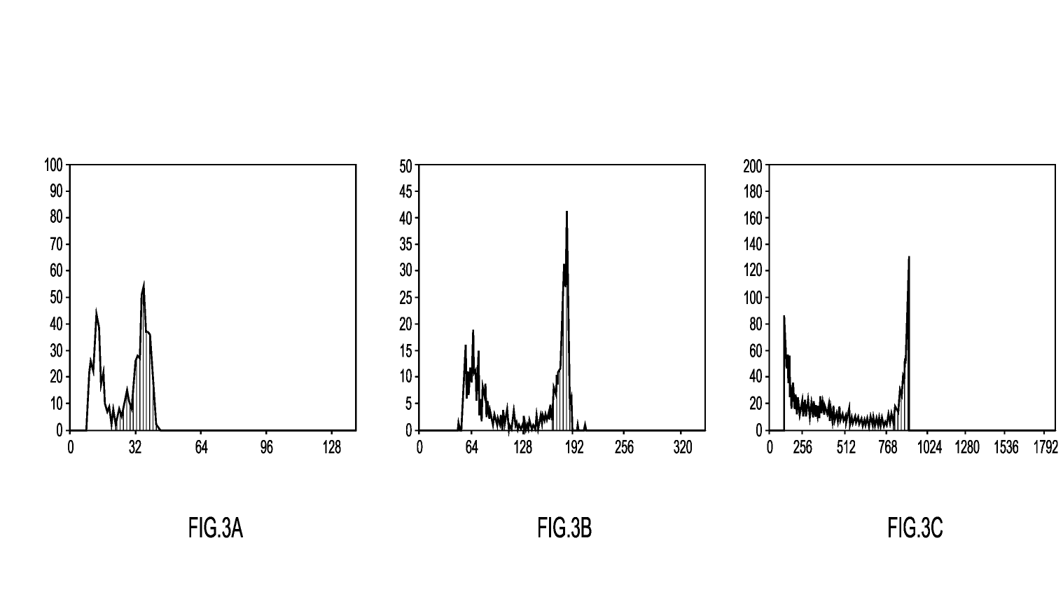

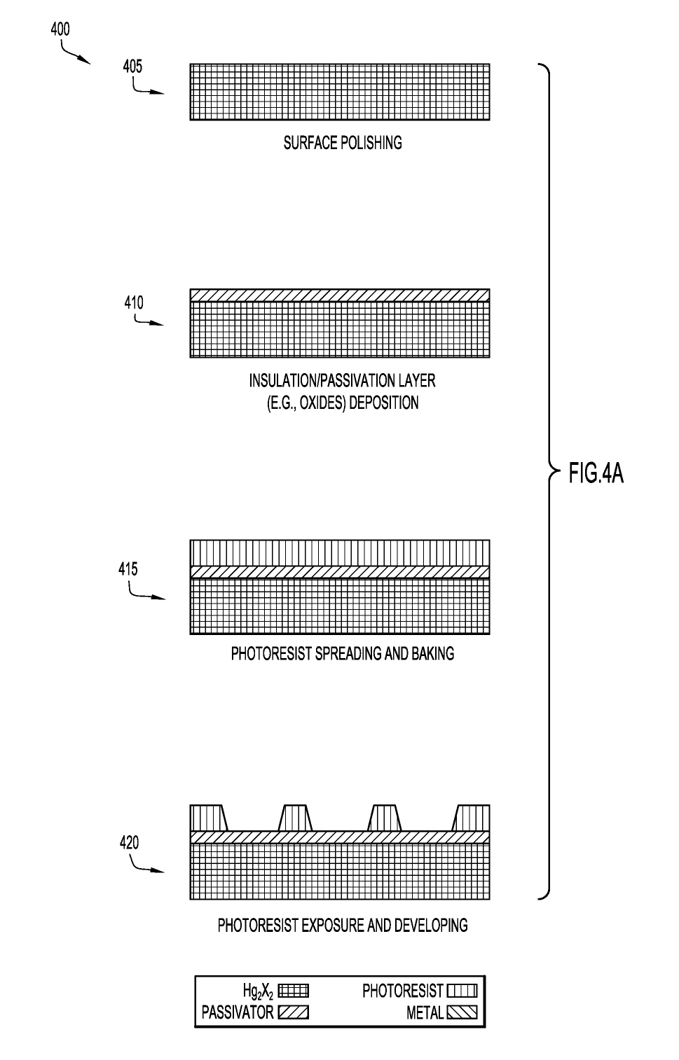

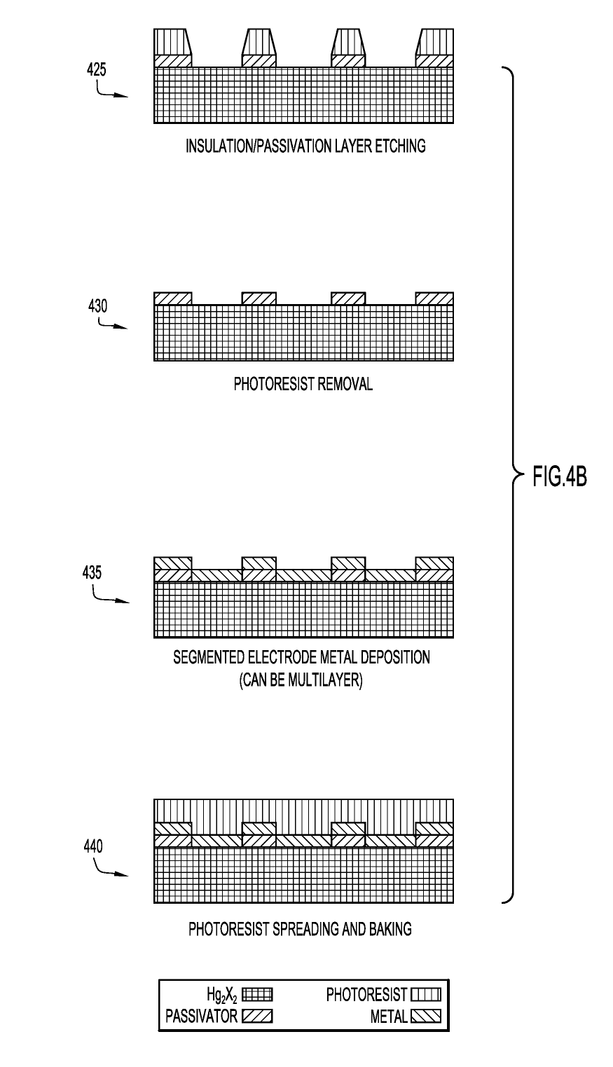

Purity is an important factor in wide bandgap semiconductor materials, as those skilled in the semiconductor arts will appreciate. The difference in detector performance due to different material qualities can clearly be seen in FIGS. 3A-3C, collectively referred to herein as FIG. 3, where there is an increase in purity from FIG. 3A to FIG. 3C. As is illustrated in the figures, Am-241 spectral response of 0.5 mm-thick planar mercurous iodide material from a less pure material (FIG. 3A) is clearly worse compared to that of the more purity optimized material of FIG. 3B. Energy resolution of Am-241 59.6 keV improves from 15% to 3% FWHM level, at room-temperature, due to the significant reduction of impurities and their oxygen-bearing complexes. In either case, beside the 59.6 keV gamma peak, the 14, 18, 21 keV x-rays peaks and the 26.4 keV escape peak can be well resolved, indicating that mercurous halide may serve as a room-temperature x-ray and gamma-ray detector material. An even better result can be seen in FIG. 3C where <2% ER can be seen. The electron mobility-lifetime product for the material represented in FIG. 3A is approximately 5×10⁻⁴, that for the material represented in FIG. 3B is 2.5×10⁻³ and that for the material represented in FIG. 3C is 10⁻³.

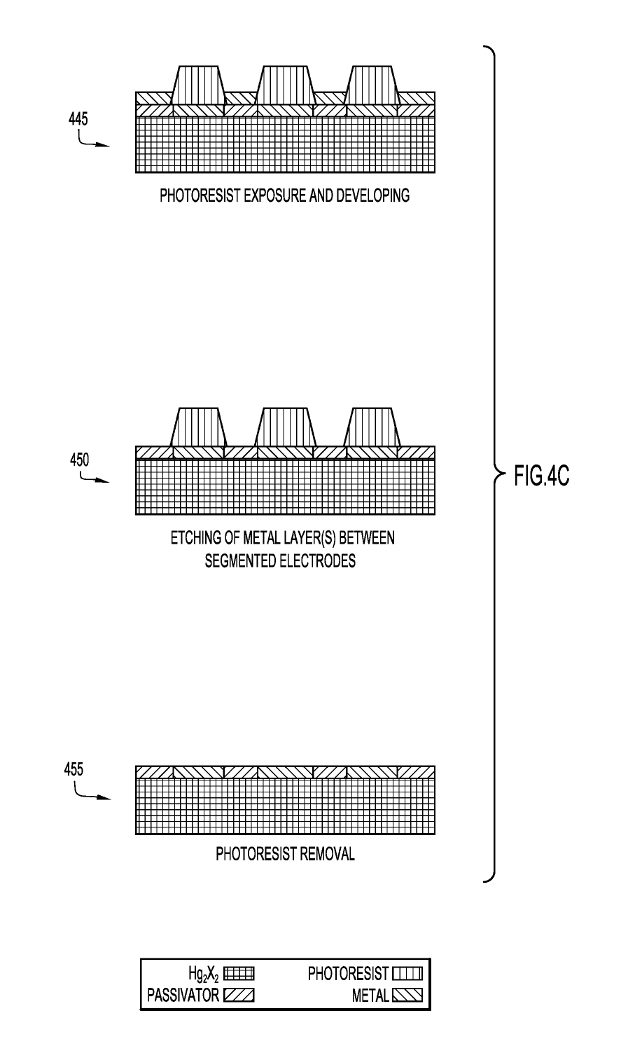

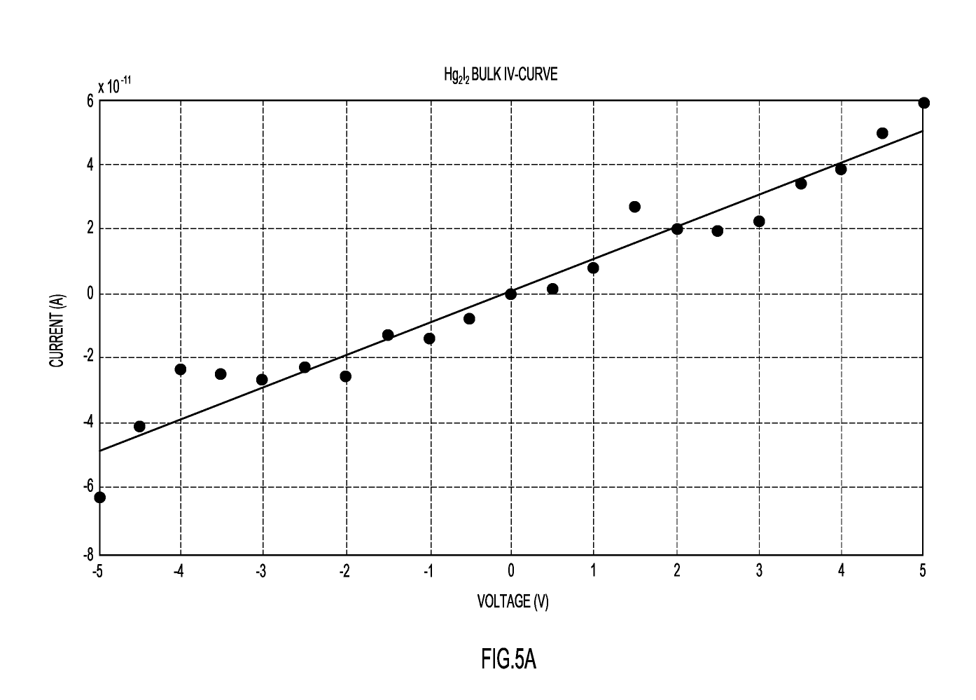

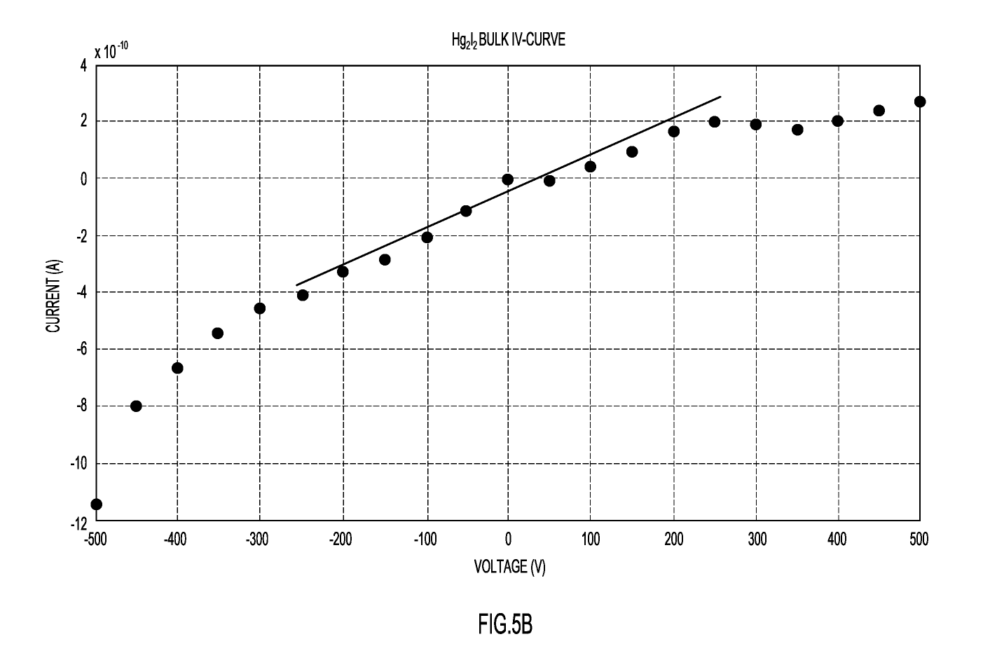

Device-specific processing 240 is, of course, dependent upon the form of the detector being fabricated. FIGS. 4A-4C, collectively referred to herein as FIG. 4, depicts an example of such processing. After being cut from the boule, a mercurous halide substrate may be polished to an optical quality surface finish in operation 405. Surface damage may be removed with chemicals such as by one or more suitable acids. In operation 410, the substrate may be passivated with an insulating layer, either chemically via CVD (chemical vapor deposition) or via physical deposition methods. In operation 415, a suitable photoresist material may be applied to the substrate and in operation 420, the photoresist layer may be suitably exposed and developed to define charge-collecting electrode areas. In operation 425, the insulating/passivation layer may be etched in the charge-collecting electrode areas and in operation 430, the photoresist material may be removed from the substrate. In operation 435, electrode metal may be deposited and, in operation 440, photoresist material is once again applied over the substrate. In operation 445, the newly-applied photoresist layer is etched to expose the contact material that is disposed between contact regions, which is then etched away in operation 450. In operation 455, the photoresist material is once again removed from the substrate to complete the electrode forming process.

In addition to the electron mobility-lifetime product, resistivity is a parameter that establishes the potential performance of a semiconductor nuclear detector. It is important to separate bulk resistivity from that of device (apparent) resistivity. Bulk resistivity can generally be derived from measuring the IV curve at very low bias voltage around the zero point where the impact of surface and metal contacts are negligible. FIG. 5A is a current vs. voltage (IV) plot of detector grade Hg₂I₂ from which bulk resistivity can be ascertained. As is illustrated in the IV plot of FIG. 5A, the bulk resistivity of the example Hg₂I₂ typically falls in the range of 6 x 10¹¹ to 2×10¹² ohm-cm. Ascertaining device resistivity, on the other hand, is not as straight forward since device IV curves typically exhibit complex surface and contact effects, which require further analysis. As is illustrated in FIG. 5B, a linear fit in the lower hundreds of volts region reveals an apparent device resistivity in the range of 5×10¹² to 10¹³ ohm-cm.

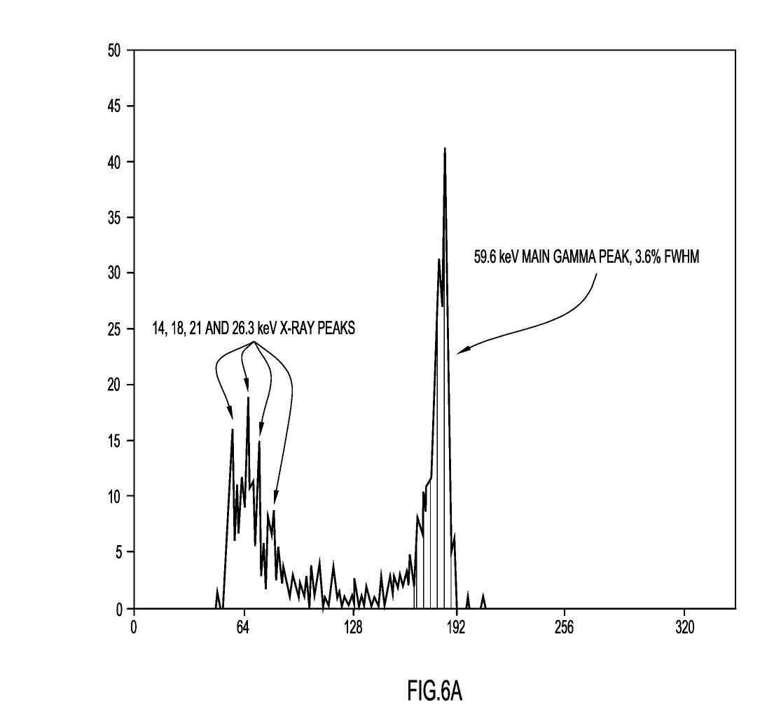

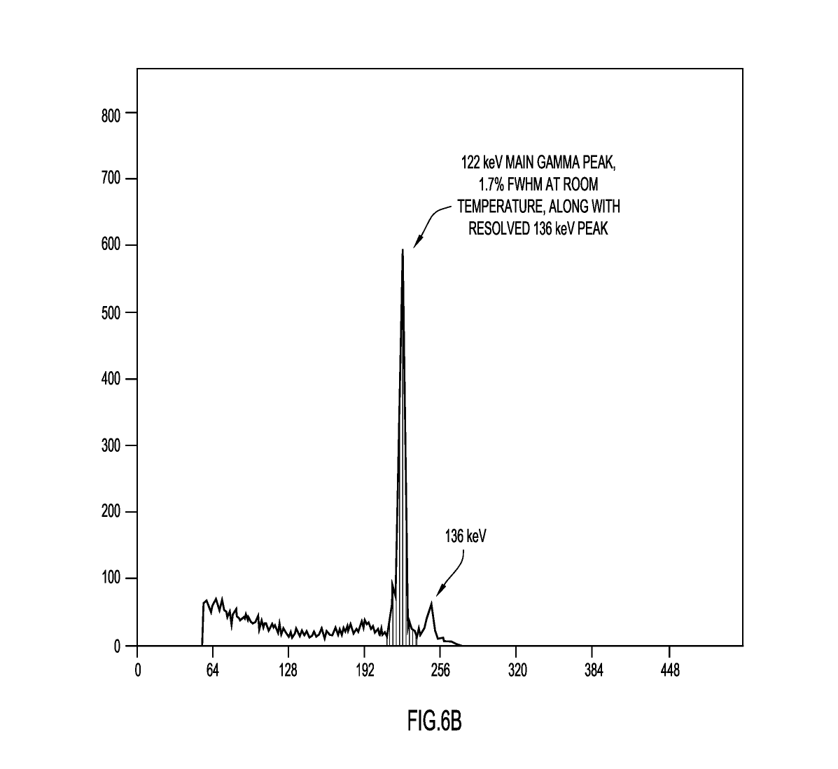

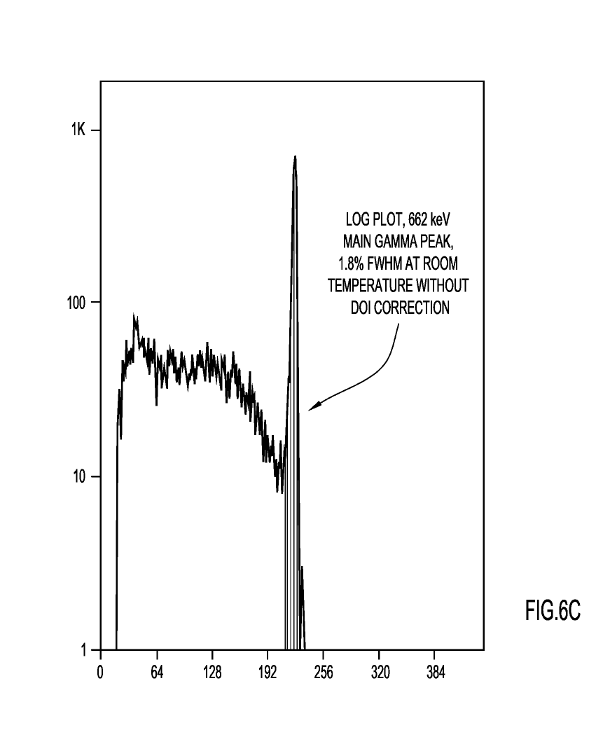

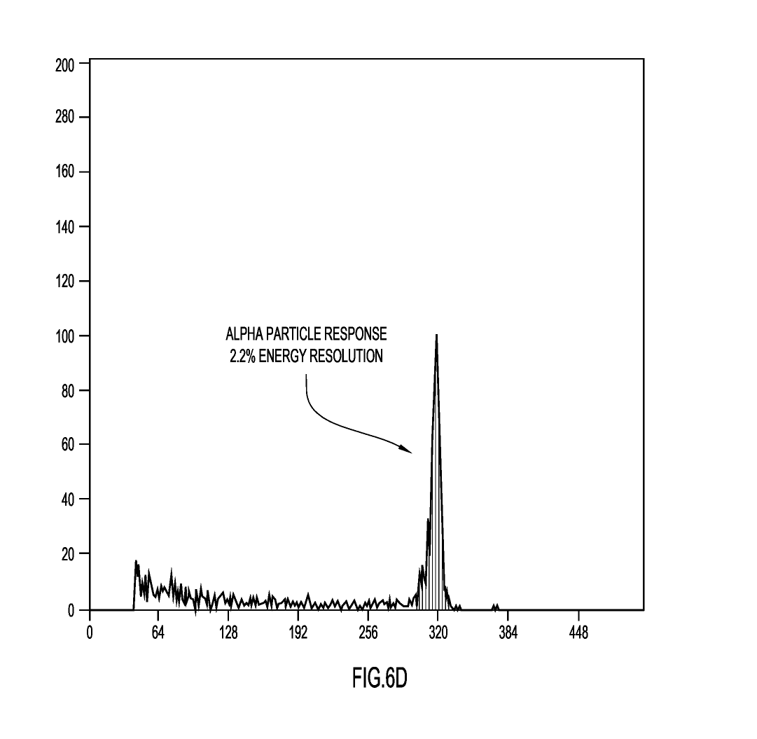

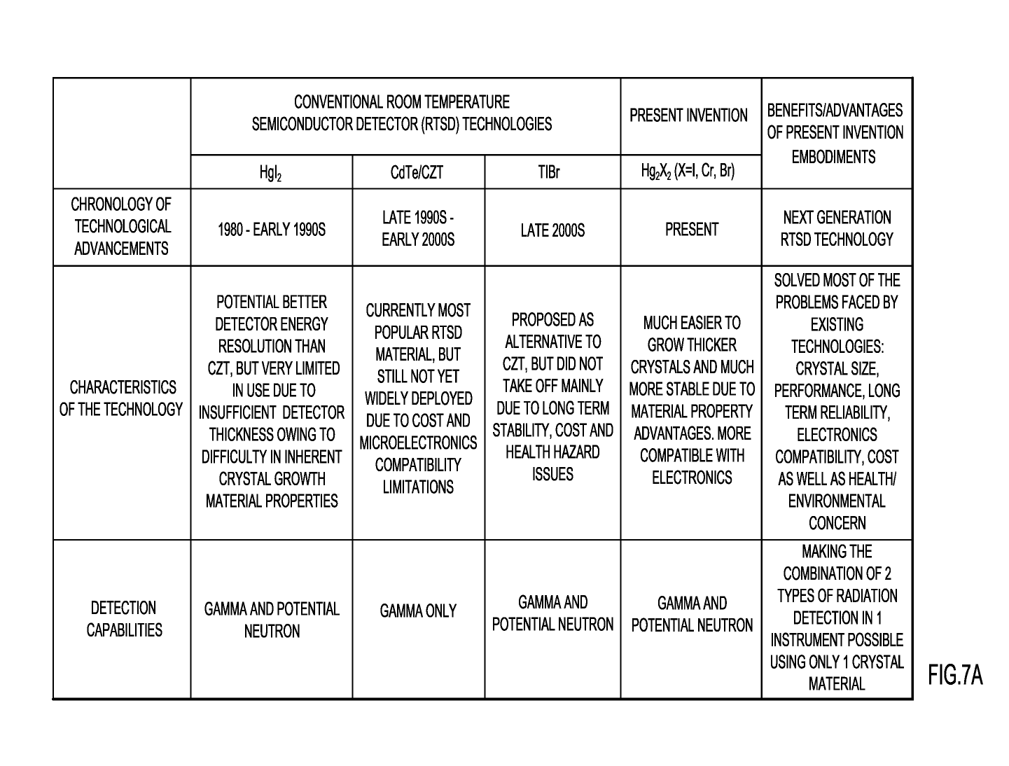

FIGS. 6A-6D are spectral response graphs of certain embodiments of the present invention. FIG. 6A is a spectral response graph of a 0.5 mm thick, rectangular planar Hg₂I₂ detector material with epoxy electrodes under 1700 V bias voltage at room-temperature. The sample was exposed to Am-241 x-rays and gamma rays. As illustrated in the figure, 14 keV, 18 keV, 21 keV and 26.3 keV x-ray peaks are clearly resolved, as indicated at the arrows. These results demonstrate applicability of embodiments of the present invention in medical x-ray imaging, x-ray spectroscopy and baggage scanning applications. Also resolved is a 59.6 keV gamma ray peak with 3.6% FWHM. It is to be noted that both x-rays and gamma rays are captured in analytically measurable electrical responses in the same Hg₂I₂ material.

FIG. 6B is a spectral response graph of a 3 mm thick, pseudo-hemispherical Hg₂Br₂ material with an approx. 2.5 mm diameter anode and an approx. 100 mm2 cathode under 2700 V bias at room-temperature. The material sample was exposed to Co-57 gamma rays. A 122 keV main gamma ray peak is resolved at 1.7% FWHM from a 136 keV gamma ray peak. These results demonstrate applicability of embodiments of the present invention in, among other things, nuclear medicine.

FIG. 6C is a logarithmic spectral response graph of 6 mm pixelated Hg2Br2 material under 1000 V bias at room-temperature. The sample was exposed to Cs-137 gamma rays. A 662 keV gamma ray peak is clearly resolved at 1.8% FWHM without depth of interaction (DOI) correction.

FIG. 6D is a spectral response graph of a 2 mm thick pseudo-hemispherical Hg2I2 material sample with an approx. 50 mm² cathode and 2 mm diameter anode under 2500 V bias at room-temperature. The sample was exposed to 5.5 MeV alpha emissions. As is illustrated in the figure, alpha particles are resolved at 2.2% FWHM, which demonstrates applicability of embodiments of the present invention in, among other things, charged particle and neutron detection of security and space applications.

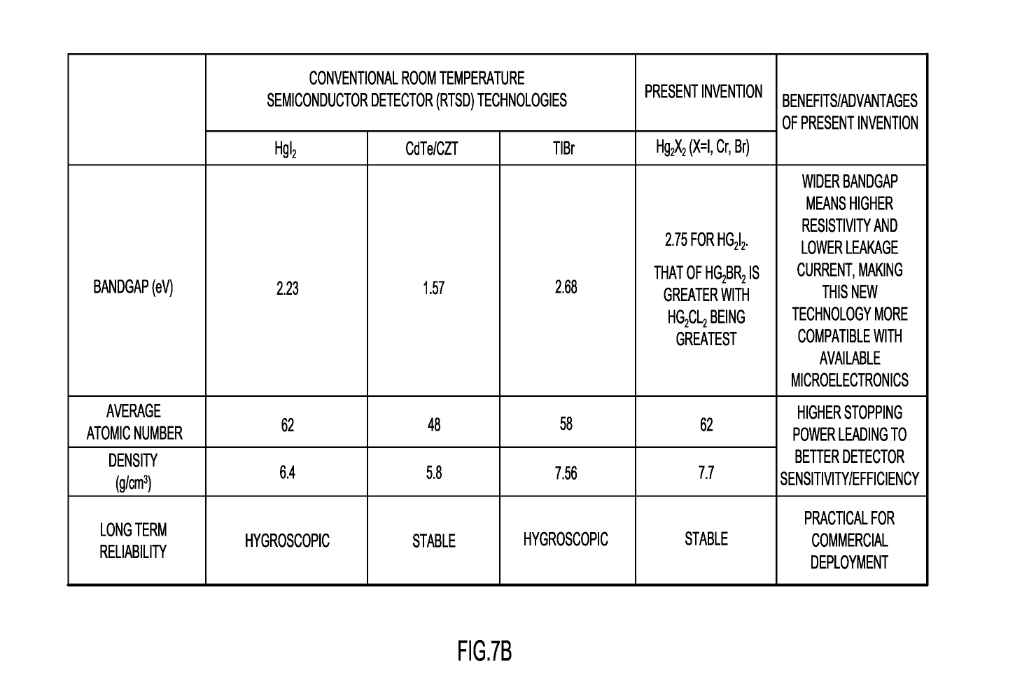

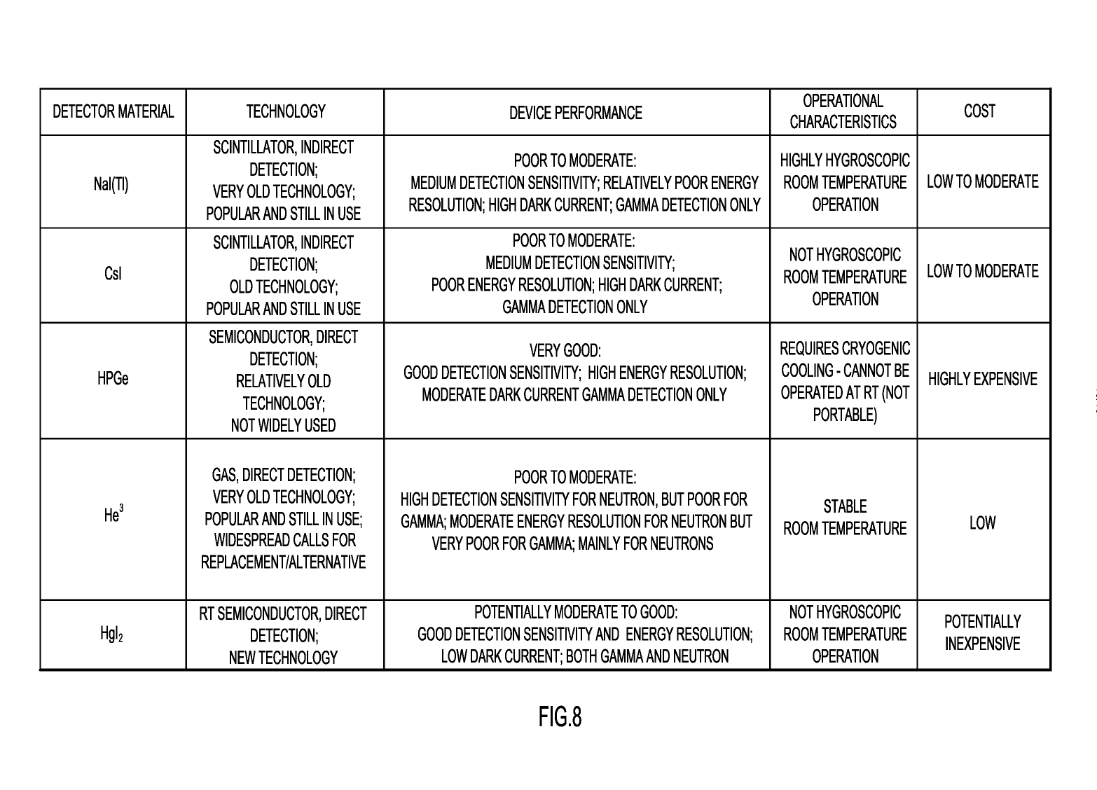

FIGS. 7A-7B summarizes various advantages and/or benefits of embodiments of the present invention over representative existing room-temperature semiconductor radiation detection technologies. FIG. 8 summarizes various advantages and/or benefits of embodiments of the present invention over non-room-temperature semiconductor technologies and representative scintillator-based and gas-based detector technologies.

The descriptions above are intended to illustrate possible implementations of the present inventive concept and are not restrictive. Many variations, modifications and alternatives will become apparent to the skilled artisan upon review of this disclosure. For example, components equivalent to those shown and described may be substituted therefore, elements and methods individually described may be combined, and elements described as discrete may be distributed across many components. The scope of the invention should therefore be determined not with reference to the description above, but with reference to the appended claims, along with their full range of equivalents.

What is claimed is:

1. A nuclear radiation detector comprising:
a solid-state detector material of formula Hg₂X₂, wherein X is a halogen, the material being formulated to produce an analytically measurable electrical response to ionizing radiation at a temperature of between 20° C. and 25° C., inclusive; and
one or more electrodes disposed on the detector material at which the electrical response is obtained.

2. The detector of claim 1, wherein the halogen is iodine.

3. The detector of claim 1, wherein the halogen is chlorine.

4. The detector of claim 1, wherein the halogen is bromine.

5. The detector of claim 1, wherein the electrodes include one or more anodes and a cathode.

6. The detector of claim 5, wherein the one or more anodes comprise a single anode disposed on a pseudo-hemispherical surface of the detector material.

7. The detector of claim 5, wherein the one or more anodes comprise an array of anodes disposed on a planar surface of the detector material.

8. The detector of claim 1, wherein the detector material is at least 99.9999% pure mercurous halide.

9. A method of detecting nuclear radiation comprising:
forming a detector active region of a semiconductor detector material having formula Hg₂X₂, wherein X is a halogen;
establishing a temperature of between 20° C. and 25° C., inclusive, in the detector material;
disposing one or more electrodes on the detector material; and
obtaining an electrical response from the detector material at the electrodes in response to the nuclear radiation.

10. The method of claim 9, wherein the halogen of the detector material is iodine.

11. The method of claim 9, wherein the halogen of the detector material is chlorine.

12. The method of claim 9, wherein the halogen of the detector material is bromine.

13. The method of claim 9, wherein disposing the one or more electrodes comprises disposing one or more anodes and a cathode on the detector material.

14. The method of claim 13, wherein disposing the one or more anodes and a cathode on the detector material comprises disposing a single anode on a pseudo-hemispherical surface of the detector material.

15. The method of claim 13, wherein disposing the one or more anodes and a cathode on the detector material comprises disposing an array of anode on a planar surface of the detector material.

16. The method of claim 9 further comprising:
purifying the detector material to at least 99.9999% pure mercurous halide.
